(19) United States
(12) Patent Application Publication
(10) Pub. No.: US 2022/0087797 A1
(43) Pub. Date: Mar. 24, 2022

(54) DualHead Flossing Device

(71) Applicant: Pedram Nazeri, Leesburg, VA (US)

(72) Inventor: Pedram Nazeri, Leesburg, VA (US)

(21) Appl. No.: 17/029,393

(22) Filed: Sep. 23, 2020

(51) Int. Cl. A61C 15/04

(52) U.S. Cl. CPC A61C 15/046

(57) ABSTRACT

A dual-head flossing device. The dual-head flossing device includes an elongated body having a first end opposite a second end. A first floss head assembly is disposed on the first end, and a second floss head assembly is disposed on the second end. Each of the first and second floss head assemblies include arcuate arms having a length of floss therebetween. In one embodiment, the first and second floss head assemblies each include a pair of arcuate arms with floss therebetween. In this embodiment, the first floss head assembly includes a first pair of arcuate arms parallel to each other, and the second floss head assembly includes a second pair of arcuate arms disposed such that an acute angle is formed therebetween.

### BACKGROUND OF THE INVENTION

The present invention relates to flossing devices. More particularly, the present invention pertains to a flossing device having a dual-head design wherein each of the dual-heads are disposed perpendicularly to each other.

Many individuals use dental floss to clean between their teeth, particularly after a meal. However, dental floss is often difficult and awkward to use, especially in a public setting, as one must wrap floss around their fingers and insert their fingers into their mouths to fully clean between every tooth. While this is not unacceptable behavior outright, it may be looked on unfavorably in a public setting as it could produce feelings of discomfort or disgust in those who witness it.

Typical disposable floss picks are readily available and often comprise a single head with a length of floss extending between two prongs or opposite ends of an arm. These floss picks generally have permanently affixed floss, which requires a user to carry an abundance of floss picks to replace after each meal. Additionally, these traditional floss picks can be time consuming and inefficient to use as the single length of floss is only capable of cleaning the space between two adjacent teeth at one time. Therefore, a device that is readily portable that allows a user to easily, efficiently, and discreetly clean around the entirety of each tooth at one time is desired.

In light of the devices disclosed in the known art, it is submitted that the present invention substantially diverges in design elements from the known art and consequently it is clear that there is a need in the art for an improvement to existing flossing devices. In this regard, the instant invention substantially fulfills these needs.

### SUMMARY OF THE INVENTION

In view of the foregoing disadvantages inherent in the known types of flossing devices now present in the known art, the present invention provides a dual-head flossing device wherein the same can be utilized for providing convenience for the user when flossing around an entire outer surface of a tooth simultaneously.

In one embodiment, the present system comprises an elongated body having a first end disposed opposite a second end. A first arcuate arm is affixed to the first end, wherein the first arcuate arm is disposed perpendicularly to a longitudinal axis of the elongated body. A second arcuate arm is affixed to the second end, wherein the second arcuate arm is disposed colinearly with the longitudinal axis of the elongated body. A length of floss extends between opposing ends of the first and second arcuate arms.

In one embodiment, a grip is disposed on a central portion of the elongated body, the grip having a diameter greater than that of the elongated body. The grip is configured to provide a cushioned grip, while also increasing frictional engagement with a user's hand.

In another embodiment, a first portion of the elongated body is removably securable to a second section of the elongated body, providing access to an interior volume of the elongated body, wherein a toothpick is disposed within the interior volume. In this way, the user is provided an additional tool for tooth cleaning purposes.

In an alternate embodiment, the present system comprises an elongated body having a first end opposite a second end. A first floss head assembly is disposed on the first end, wherein the first floss head assembly comprises a first pair of arcuate arms disposed parallel to each other. A second floss head assembly is disposed on the second end, wherein the second floss head assembly comprises a second pair of arcuate arms, wherein a proximal end of each of the second pair of arcuate arms is affixed to the second end. A linear distance between a distal end of the each of the second pair of arcuate arms is greater than a linear distance between the proximal end of each of the second pair of arcuate arms. A length of floss extends between each of the first and second pairs of arcuate arms.

In some embodiments, a pair of elastic members extend transversely between the lengths of floss of the first floss head assembly. In another embodiment, the pair of elastic members are disposed parallel to each other. In other embodiments, the pair of elastic members further comprise a plurality of bristles thereon, the plurality of bristles extending radially outward from each of the pair of elastic members. In yet another embodiment, a section of each length of floss between the pair of elastic members further comprises a plurality of bristles extending radially outward therefrom. In this way, the entirety of a tooth can be surrounded when flossing with the first floss head assembly, allowing the bristles to clean every exterior surface of the tooth.

In some embodiments, a pair of elastic members extend transversely between the lengths of floss of the second floss head assembly. In other embodiments, the pair of elastic members are disposed parallel to each other. In another embodiment, the pair of elastic members further comprise a plurality of bristles thereon, the plurality of bristles extending radially outward from each of the pair of elastic members. In yet another embodiment, a second of each length of floss between the pair of elastic members further comprises a plurality of bristles extending radially outward therefrom. In this way, the bristles of the second floss head assembly are positioned to clean every exterior surface of a tooth simultaneously.

In another embodiment, a depth of each of the first and second pairs of arcuate arms is less than a height between an occlusal surface of a tooth and interdental papillae, thereby preventing the length of floss from damaging the gums of a user.

In some embodiments, the first pair of arcuate arms are disposed perpendicular to a longitudinal axis of the elongated body. In another embodiment, an angle between the second pair of arcuate arms is between 10-degrees and 45-degrees. In other embodiments, the second pair of arcuate arms are pivotally secured to the second end at the proximal end thereof. In yet another embodiment, a circular elastic member is affixed between the lengths of floss of the first floss head assembly, the circular elastic member having a plurality of bristles extending radially outward therefrom.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an embodiment of the dual-head flossing device.

FIG. 1B shows a perspective view of an alternate embodiment of the dual-head flossing device.

FIG. 2A shows a close-up view of the first floss head assembly of an embodiment of the dual-head flossing device.

FIG. 2B shows a close-up view of the first floss head assembly of an alternate embodiment of the dual-head flossing device.

FIG. 2C shows a close-up view of the first floss head assembly of yet another embodiment of the dual-head flossing device.

FIG. 3A shows a close-up view of an embodiment of the second floss head assembly of an embodiment of the dual-head flossing device.

FIG. 3B shows a close-up view of an embodiment of the second floss head assembly of an embodiment of the dual-head flossing device.

FIG. 4 shows an exploded view of an embodiment of the dual-head flossing device.

FIG. 5 shows a perspective view of an embodiment of the dual-head flossing device in use.

### DETAILED DESCRIPTION OF THE INVENTION

Reference is made herein to the attached drawings. Like reference numerals are used throughout the drawings to depict like or similar elements of the dual-head flossing device. The figures are intended for representative purposes only and should not be considered to be limiting in any respect.

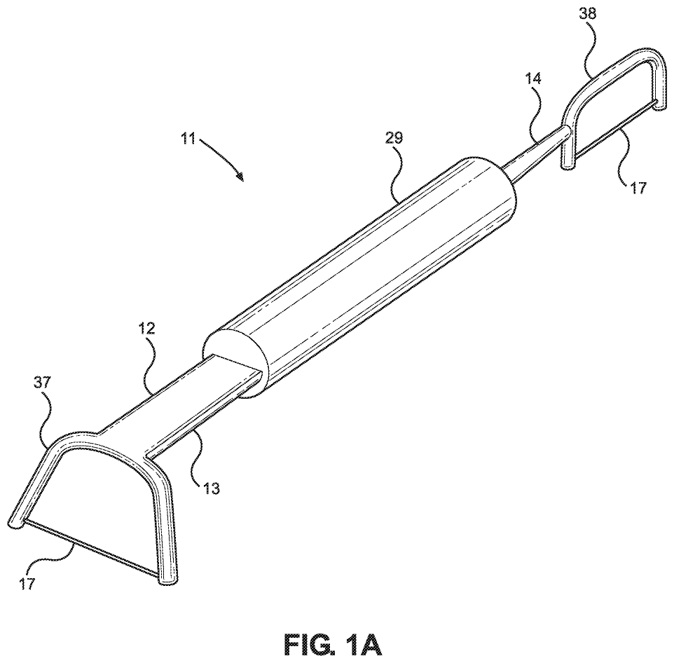

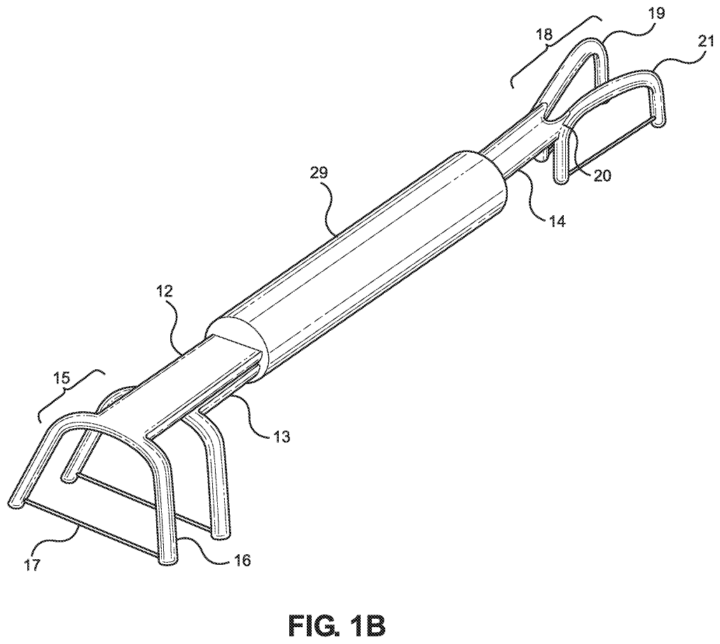

Referring now to FIGS. 1A and 1B, there are shown perspective views of various embodiments of the dual-head flossing device. The dual-head flossing device 11 comprises an elongated body 12 having a first end 13 opposite a second end 14. A first floss head assembly 15 is disposed on the first end 13, and a second floss head assembly 18 is disposed on the second end 14. It is contemplated that the first and second floss head assemblies 15, 18 can comprise any configuration and combination of configurations disclosed herein, and not merely those shown and disclosed in the accompanying figures. The elongated body 12 further comprises a grip 29 disposed thereon, wherein the grip 29 is configured to provide a high-friction gripping surface for the user. The grip 29 can comprise a variety of materials maximizing frictional engagement with a user or comfort, such as rubber or the like. In some embodiments, the grip 29 is a rigid grip, whereas, in alternate embodiments, the grip 29 comprises a cushioned surface. In the illustrated embodiment, the grip 29 comprises a greater diameter than that of the elongated body 12 and extends along a central portion of the elongated body 12 between the first and second ends 12, 13 thereof. In some embodiments, the elongated body 12 comprises a surgical-grade plastic material configured to inhibit bacterial and microbial growth thereon.

In the illustrated embodiment of FIG. 1A, the first floss head assembly 15 comprises a first arcuate arm 37 disposed perpendicularly relative to a longitudinal axis of the elongated body 12. A length of floss 17 is affixed to the first arcuate arm 37 such that the length of floss 17 extends between opposing ends thereof. Alternatively, in the embodiment of FIG. 1B, the first floss head assembly 15 comprises a first pair of arcuate arms 16 disposed perpendicularly relative to the longitudinal axis of the elongated body 12, such that each of the first pair of arcuate arms 16 is disposed parallel relative to each other. A length of floss 17 similarly extends between opposing ends of each of the first pair of arcuate arms 16, such that each length of floss 17 is disposed parallel to each other. In some embodiments, the length of floss 17 is integral with the first pair of arcuate arms 16, such that the dual-head flossing device 11 is disposable, while in alternate reusable embodiments, an alternate floss-securing means is contemplated, thereby providing the user with the ability to replace the floss without replacing the entire device. In such embodiments, the alternate floss-securing means can be selected from a notch disposed in the first pair of arcuate arms 16, a textured surface on the exterior of the first pair of arcuate arms 16 to aid in frictional engagement of the length of floss 17, an adhesive surface on the exterior of the first pair of arcuate arms 16, or a combination thereof. In this way, the first floss head assembly 15 of FIG. 1B can encompass opposing faces of a tooth to simultaneously clean each face thereof. In some embodiments, a distance defined between the parallel lengths of floss 17 is between 5 millimeters and 20 millimeters. In another embodiment, the distance between the parallel lengths of floss 17 of the first floss head assembly 15 can be adjusted, such that the user can define the distance therebetween for teeth of various widths. In this way, an outermost arcuate arm of the first pair of arcuate arms 16 can be slidably disposed within the elongated body 12, such that the outermost arcuate arm is selectively movable to define the distance. In some embodiments, each length of floss 17 is impregnated with an antibacterial solution, such that each face of the tooth is sanitized thereby. This ensures that any bacteria or the like remaining on the surface of the tooth after being scrubbed with the length of floss 17 is rendered inert by the antibacterial solution.

In the shown embodiment of FIG. 1A, the second floss head assembly 18 comprises a second arcuate arm 38 extending colinearly from the elongated body 12 at the second end 14 thereof. In this way, the second arcuate arm 38 is disposed perpendicularly relative to the first arcuate arm 37. This arrangement allows a user to floss between teeth from various angles, allowing a user to select the most comfortable or efficient floss head assembly 15, 18 to clean the desired area. Similar to the first floss head assembly 15, a length of floss 17 extends between opposing ends of the second arcuate arm 38.

In the illustrated embodiment of FIG. 1B, the second floss head assembly 18 comprises a second pair of arcuate arms 19, wherein a proximal end 20 of each of the second pair of arcuate arms 19 is affixed to the second end 14 of the elongated body 12. A length of floss 17 extends between opposing ends of each of the second pair of arcuate arms 19. Similar to the first floss head assembly 15, the length of floss 17 can be integral with the second pair of arcuate arms 19, or alternatively the second pair of arcuate arms 19 can comprise a floss-securing means as previously described. An angle is defined therebetween, such that a linear distance between a distal end 21 of each of the second pair of arcuate arms 19 is greater than a linear distance between the proximal end 20 thereof. In some embodiments, the angle defined therebetween is between 10-degrees and 45-degrees. In another embodiment, the proximal end 20 of each of the second pair of arcuate arms 38 is pivotally secured to the second end 14, such that the angle therebetween is adjustable. In this way, the user can select a desirable angle for cleaning between teeth of various widths.

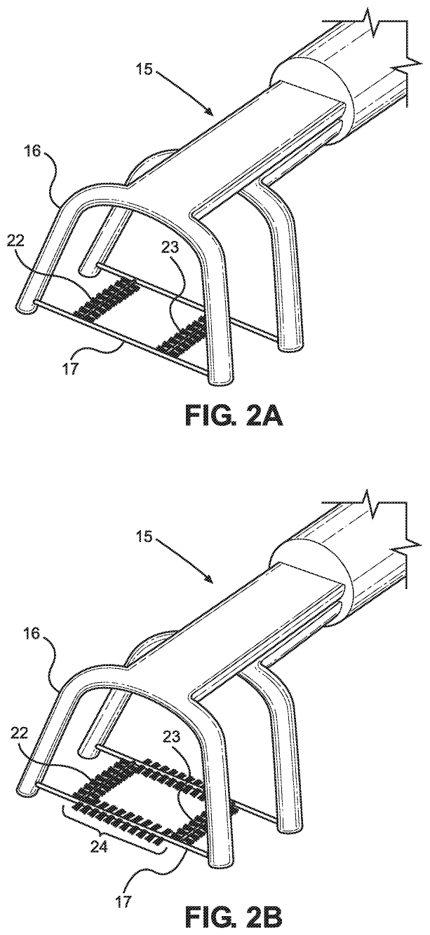

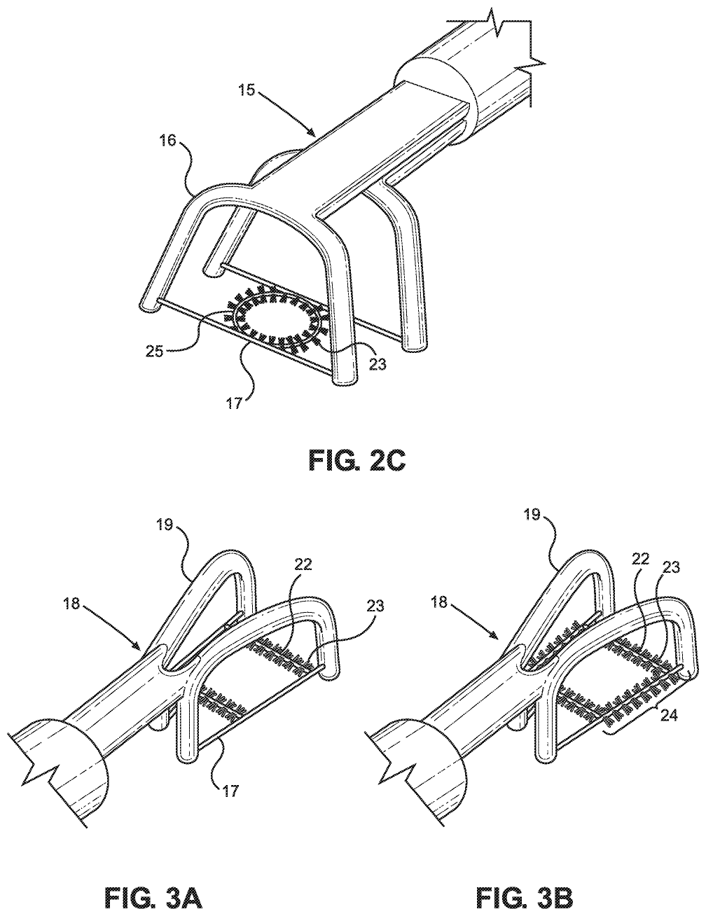

Referring now to FIGS. 2A, 2B, and 2C, there are shown close-up views of the first floss head assembly of various embodiments of the dual-head flossing device. In the illustrated embodiments of FIGS. 2A, 2B, elastic members 22 extend transversely between each length of floss 17 disposed between the first pair of arcuate arms 16. In this way, the first floss head assembly 15 is configured to fully encircle an individual tooth, allowing each side thereof to be cleaned simultaneously. The elastic nature of the elastic members 22 allows the first floss head assembly 15 to accommodate teeth of various sizes while exerting an inward force thereagainst, allowing the tooth surfaces to be cleaned thereby.

The elastic members 22 can comprise a variety of configurations. In the illustrated embodiment of FIG. 2A, the elastic members 22 further comprise a plurality of bristles 23 extending therefrom, wherein the plurality of bristles 23 are configured to scrub opposing outer surfaces of a tooth, as well as any surfaces of neighboring teeth in contact with the plurality of bristles 23. In some embodiments, the plurality of bristles 23 extend from the elastic members 22 about an entire circumference thereof. In the shown embodiment of FIG. 2B, a section 24 of the length of floss 17 further comprises a plurality of bristles 23 extending therefrom. In this way, the entire outer surface of a tooth can be simultaneously scrubbed by the plurality of bristles 23 fully encompassing the tooth. The embodiments shown in FIGS. 2A and 2B are optimally used to clean molars and other primarily rectangularly shaped teeth.

In the illustrated embodiment of FIG. 2C, the first floss head assembly 15 further comprises a circular elastic member 25 affixed tangentially between each length of floss 17 of the first pair of arcuate arms 16. The circular elastic member 25 further comprises a plurality of bristles 23 extending therefrom. Similarly, the plurality of bristles 23 can extend from the circular elastic member 25 from an entire circumference thereof, such that the plurality of bristles 23 can fully clear an outer surface of a tooth. The elastic nature of the circular elastic member 25 ensures that the circular elastic member 25 is in contact with an entirety of an outer surface of teeth of various or varying sizes, such that the elastic member 25 contours to the irregular surface of each tooth. The circular elastic member 25 is optimally used with teeth having a primarily rounded cross-section, such as incisors and the like.

Referring now to FIGS. 3A and 3B, there are shown close-up views of the second floss head assembly of various embodiments of the dual-head flossing device. In the illustrated embodiments, the second floss head assembly 18 further comprises a pair of elastic members 22 extending transversely between each length of floss 17 extending between opposing ends of the second pair of arcuate arms 19. Due to the angled nature of the second floss head assembly 18 as previously described, this leads to one of the pair of elastic members 22 having a greater length than that of the remaining elastic member 22. In the shown embodiments, the pair of elastic members 22 further comprise a plurality of bristles 23 thereon. The plurality of bristles 23 can, in some embodiments, extend about an entire circumference of the elastic members 22 to provide complete coverage across an entire tooth surface. In the shown embodiment of FIG. 3B, the section 24 of floss between the pair of elastic members 22 further comprises a plurality of bristles 23 thereon, such that the entire outer surface of the tooth to be cleaned can be effectively scrubbed thereby.

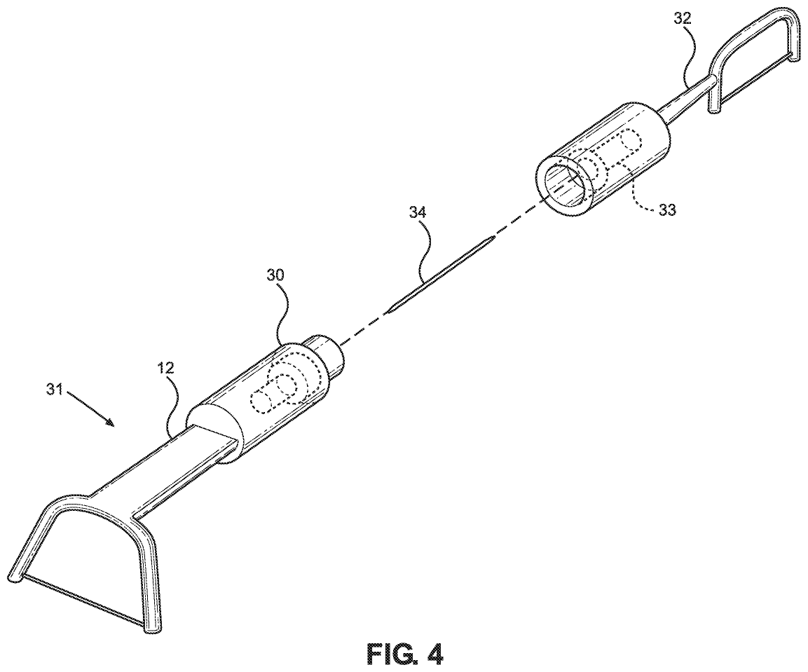

Referring now to FIG. 4, there is shown an exploded view of an embodiment of the dual-head flossing device. In the illustrated embodiment, the elongated body 12 comprises a first portion 31 removably securable to a second portion 32 via friction fit along a center portion 30 thereof. Alternate securement methods, such as threaded engagement, are also contemplated. An interior volume 33 is defined within each of the first portion 31 and the second portion 32, such that when the first portion 31 and the second portion 32 are removably secured together, the interior volume 33 is dimensioned to store an additional tool therein. In the illustrated embodiment, the interior volume 33 is dimensioned to receive a toothpick 34 therein. In this way, the user is provided with an alternate method of cleaning between adjacent teeth in situations where a toothpick 34 is more suitable.

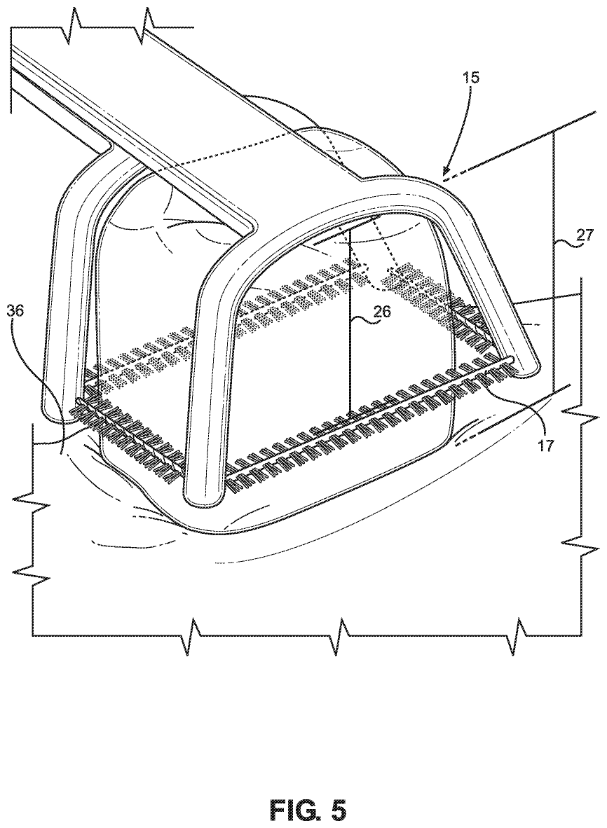

Referring now to FIG. 5, there is shown a perspective view of an embodiment of the dual-head flossing device in use. In the illustrated embodiment, a depth 26 of the first pair of arcuate arms is defined between an upper portion of the first pair of arcuate arms and the length of floss 17. In the shown embodiment, the depth 26 is dimensioned to be less than a height 27 of the tooth being cleaned, wherein the height 27 is defined between an occlusal surface of the tooth and an interdental papillae 36 between adjacent teeth, such that the height 27 corresponds to the portion of tooth exposed above the user's gumline to be cleaned. In this way, the user is ensured that the length of floss 17 or any other portion of the first floss head assembly 15 does not contact or irritate any portion of the user's gum. For the purposes of brevity, the first floss head assembly 15 is discussed, however, it is to be understood that the second floss head assembly and the second pair of arcuate arms are contemplated to have similar relationships between a depth of the second pair of arcuate arras and a height of a tooth being cleaned.

In one exemplary use, the user selects an appropriate floss head assembly for the desired cleaning purpose. For example, if the target tooth to be cleaned is primarily rectangular in shape, the first floss head assembly 15 may be chosen to ensure a thorough cleaning of the outer surface of the target tooth. The first floss head assembly 15 is then inserted into the user's mouth such that the length of floss 17 on each of the first pair of arcuate arms is positioned on opposing sides of the target tooth between the target tooth and adjacent teeth. The length of floss 17 can then be raised and lowered to clean the outer surface of the target tooth via a scrubbing action. In embodiments having a pair of elastic members transversely between each length of floss 17, the remaining outer surfaces of the target tooth can be simultaneously cleaned as the elastic members are biased towards the target tooth. In this way, the target tooth is inserted between each of the lengths of floss 17 and the pair of elastic members, fully encompassing the target tooth to allow efficient and simultaneous cleaning of every surface thereof.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A dual-head flossing device, comprising:
an elongated body having a first end opposite a second end;
a first floss head assembly disposed on the first end;
wherein the first floss head assembly comprises a first pair of arcuate arms disposed parallel to each other;
a length of floss extending between opposing ends of each of the first pair of arcuate arms;
a second floss head assembly disposed on the second end;
wherein the second floss head assembly comprises a second pair of arcuate arms, wherein a proximal end of each of the second pair of arcuate arms is affixed to the second end;
wherein a linear distance between a distal end of each of the second pair of arcuate arms is greater than a linear distance between the proximal end of each of the second pair of arcuate arms.

2. The dual-head flossing device of claim 1, further comprising a pair of elastic members extending transversely between the lengths of floss of the first floss head assembly.

3. The dual-head flossing device of claim 2, wherein the pair of elastic members are disposed parallel to each other.

4. The dual-head flossing device of claim 2, wherein the pair of elastic members further comprise a plurality of bristles thereon, the plurality of bristles extending radially outward from each of the pair of elastic members.

5. The dual-head flossing device of claim 4, wherein a section of each length of floss between the pair of elastic members further comprises a plurality of bristles extending radially outward therefrom.

6. The dual-head flossing device of claim 1, further comprising a pair of elastic members extending transversely between the lengths of floss of the second floss head assembly.

7. The dual-head flossing device of claim 6, wherein the pair of elastic members are disposed parallel to each other.

8. The dual-head flossing device of claim 6, wherein the pair of elastic members further comprise a plurality of bristles thereon, the plurality of bristles extending radially outward from each of the pair of elastic members.

9. The dual-head flossing device of claim 8, wherein a section of each length of floss between the pair of elastic members further comprises a plurality of bristles extending radially outward therefrom.

10. The dual-head flossing device of claim 1, further comprising a circular elastic member affixed between the lengths of floss of the first floss head assembly, the circular elastic member having a plurality of bristles extending radially outward therefrom.

11. The dual-head flossing device of claim 1, wherein a depth of each of the first and second pairs of arcuate arms is less than a height between an occlusal surface of a tooth and interdental papillae.

12. The dual-head flossing device of claim 1, wherein the first pair of arcuate arms are disposed perpendicular to a longitudinal axis of the elongated body.

13. The dual-head flossing device of claim 1, wherein an angle between the second pair of arcuate arms is between 10-degrees and 45-degrees.

14. The dual-head flossing device of claim 1, wherein the second pair of arcuate arms is pivotally secured to the second end of the elongated body at the proximal end thereof.

15. The dual-head flossing device of claim 1, wherein a grip is disposed on a central portion of the elongated body, the grip having a diameter greater than that of the elongated body.

16. The dual-head flossing device of claim 1, wherein a first portion of the elongated body is removably securable to a second portion of the elongated body, providing access to an interior volume of the elongated body, wherein a toothpick is disposed within the interior volume.

17. The dual-head flossing device of claim 16, wherein the first portion is removably securable to the second portion via threaded engagement therebetween.

18. A dual-head flossing device, comprising:
an elongated body having a first end disposed opposite a second end;
a first arcuate arm affixed to the first end, wherein the first arcuate arm is disposed perpendicularly to a longitudinal axis of the elongated body;
a second arcuate arm affixed to the second end, wherein the second arcuate arm is disposed colinearly with the longitudinal axis of the elongated body;
a length of floss extending between opposing ends of each the first and second arcuate arms.

19. The dual-head flossing device of claim 18, further comprising a grip disposed on a central portion of the elongated body, the grip having a diameter greater than that of the elongated body.

20. The dual-head flossing device of claim 18, wherein a first portion of the elongated body is removably securable to a second portion of the elongated body, providing access to an interior volume of the elongated body, wherein a toothpick is disposed within the interior volume.
